(19) United States
(12) Patent Application Publication
(10) Pub. No.: US 2025/0327700 A1
(43) Pub. Date: Oct. 23, 2025

(54) LIQUID LEVEL MEASUREMENT METHOD AND LIQUID LEVEL MEASUREMENT DEVICE

(71) Applicant: Tokyo Electron Limited, Tokyo (JP)

(72) Inventor: Tatsuki KANEYOSHI, Yamanashi (JP)

(21) Appl. No.: 19/254,322

(22) Filed: Jun. 30, 2025

Related U.S. Application Data
(63) Continuation of application No. PCT/JP2023/044896, filed on Dec. 14, 2023.

(30) Foreign Application Priority Data
Jan. 12, 2023 (JP) 2023-003322

(51) Int. Cl. G01F 23/2965; G01F 23/296

(52) U.S. Cl. CPC G01F 23/2965; G01F 23/2968

(57) ABSTRACT

A liquid level measurement method performed by using a liquid level measurement device including a vibrator immersed in a liquid in a container, a surface of the vibrator perpendicular to a vibration direction having a rectangular shape. The liquid level measurement method includes exciting, by a vibration exciter, vibration in the vibrator; measuring damping time during which an amplitude of the vibration generated in the vibrator is damped to a predetermined level when the excitation of the vibration in the vibrator is stopped; and calculating, based on correlation information between the damping time and a liquid level of the liquid, the liquid level corresponding to the damping time during which the amplitude of the vibration generated in the vibrator is damped to the predetermined level.

### CROSS-REFERENCE TO RELATED APPLICATIONS

This application is a continuation application of International Application No. PCT/JP2023/044896 filed on Dec. 14, 2023, and designating the U.S., which is based upon and claims priority to Japanese Application No. 2023-003322, filed on Jan. 12, 2023, the entire contents of which are incorporated herein by reference.

### BACKGROUND

### 1. Technical Field

The present disclosure relates to a liquid level measurement method and liquid level measurement device.

### 2. Description of the Related Art

Patent Document 1 proposes a detector that determines, by detecting a difference in the amplitude between an electric signal caused in a case where a particulate material or liquid in a container is pressing a vibrator in the container and a case where it is not, whether a level of the particulate material or liquid has reached a predetermined level.

Patent Document 2 proposes a liquid level meter that measures the liquid level using a vibrator. The liquid level meter includes a detection unit, exposed from a housing, of an I-shaped vibrating element using lateral vibration of a rod, and detects a level of a particulate material that constrains the vibration of the I-shaped vibrating element due to the fact that the vibration is damped and stopped when the particulate material comes into contact with and constrains the detection unit, and started again when the particulate material is removed.

Patent Document 3 proposes a liquid level meter including a vibrator and a vibration mechanism that excites vibration in the vibrator. The vibrator is partially inserted into a stored liquid through a liquid surface and the free vibration frequency of the vibrator changes in accordance with the liquid level of the liquid. The liquid level meter includes a frequency detection unit that detects the free vibration frequency of the vibrator along with the excitation of vibration, and a unit that calculates and displays the liquid level based on the output of the frequency detection unit.

### RELATED ART DOCUMENT

### Patent Document

Patent Document 1: Japanese Laid-Open Patent Application Publication No. 552-12860
Patent Document 2: Japanese Laid-Open Patent Application Publication No. S54-37782
Patent Document 3: Japanese Laid-Open Patent Application Publication No. S60-202311

### SUMMARY

According to one embodiment of the present disclosure, a liquid level measurement method performed by using a liquid level measurement device including a vibrator immersed in a liquid in a container, a surface of the vibrator perpendicular to a vibration direction having a rectangular shape. The liquid level measurement method includes exciting, by a vibration exciter, vibration in the vibrator; measuring damping time during which an amplitude of the vibration generated in the vibrator is damped to a predetermined level when the excitation of the vibration in the vibrator is stopped; and calculating, based on correlation information between the damping time and a liquid level of the liquid, the liquid level corresponding to the damping time during which the amplitude of the vibration generated in the vibrator is damped to the predetermined level.

### BRIEF DESCRIPTION OF THE DRAWINGS

FIG. 1 is a diagram illustrating an example of a container to which a liquid level measurement device according to an embodiment is fixed;

FIG. 2 is a flowchart illustrating an example of a liquid level measurement method according to the embodiment;

FIG. 3 is a graph indicating an example of the amplitude of vibration generated in a vibrator included in the liquid level measurement device according to the embodiment;

FIG. 4A is a diagram illustrating an analysis model according to the embodiment;

FIG. 4B is a diagram illustrating an analysis model according to the embodiment; and

FIG. 5 is a diagram illustrating an example of a vaporizer and a film deposition apparatus according to the embodiment.

### DETAILED DESCRIPTION

According to one aspect, the liquid level in a container can be accurately measured.

Embodiments of the present disclosure will be described below with reference to the drawings. In the drawings, the same components are denoted by the same reference numerals, and duplicate descriptions may be omitted.

In the present specification, in the directions, such as parallel, perpendicular, orthogonal, horizontal, vertical, up and down, left and right, deviations that do not impair the effect of the embodiment are permitted. The shape of the corners is not limited to a right angle, but may be rounded in an arcuate shape. Parallel, perpendicular, orthogonal, horizontal, vertical, a circle, and equivalent may include approximately parallel, approximately perpendicular, approximately orthogonal, approximately horizontal, approximately vertical, approximately a circle, and approximately equivalent.

### Introduction

A float switch is an example of a technique for measuring the liquid level of a liquid stored in a tank (container) used in a vaporizer or the like. Additionally, a level switch that detects whether a liquid or a particulate material is in contact with a vibrator by exciting vibration in the vibrator using an actuator and then detecting whether the vibration is damped when the excitation of the vibration is stopped is an example of a technique for measuring the liquid level using vibration.

The float switch floats, on a liquid, a float having a certain amount of volume to generate buoyancy, and thus the amount of liquid that can be accommodated in the tank becomes small. Additionally, the liquid level is measured by turning on and off the switch due to the vertical movement of the float, and thus only information such as whether the liquid level is above or below one specific level per float can be detected. By increasing the number of floats, the liquid level at multiple points can be detected, but the amount of liquid that can be accommodated in the tank further decreases due to the floats. Additionally, the liquid level is measured at discrete points.

The level switch measures one liquid level by detecting whether one vibrator is in contact with a liquid or a particulate material, and thus it is necessary to use multiple vibrators to measure multiple liquid levels.

With respect to the above, the present embodiment provides a liquid level measurement device that can measure the liquid level linearly (continuously) by the length of the vibrator while avoiding the decrease of the amount of liquid that can be accommodated in the tank. With this, the liquid level in a container 110 can be measured with higher accuracy.

### [Liquid Level Measurement Device]

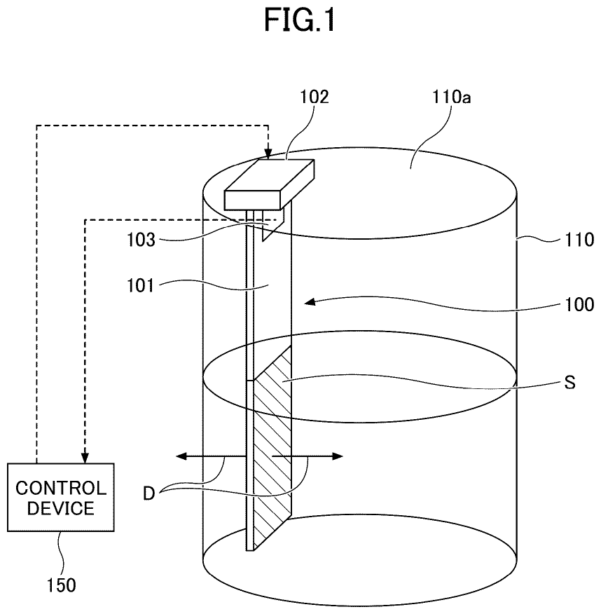

A liquid level measurement device 100 according to an embodiment will be described with reference to FIG. 1. FIG. 1 is a diagram illustrating an example of the container 110 to which the liquid level measurement device 100 according to the embodiment is fixed.

A liquid is stored in the container 110. The container 110 is made of a material that is resistant to corrosive liquids, such as stainless steel. For example, the container 110 is a tank such as a vaporizer.

The liquid level measurement device 100 includes a vibrator 101 immersed in the liquid in the container 110, a vibration exciter 102, a vibration sensor 103, and a control device 150. The vibrator 101 is a plate member, has a certain degree of hardness and flexibility, and vibrates in a vibration direction D. The vibrator 101 has a thin thickness in the vibration direction D and a surface perpendicular to the vibration direction D has a rectangular shape. The vibrator 101 is made of a material that is resistant to corrosive liquids, such as stainless steel, which may be the same material of the container 110, for example. The vibrator 101 is not limited to a plate shape and may be a rod shape, but it is preferable to have a thickness and a shape susceptible to vibration.

The vibration exciter 102 is attached to an upper end of the vibrator 101 and vibrates the vibrator 101. The initial vibration of the vibrator 101 may be close to the natural frequency of the vibrator 101, but is not limited thereto. Additionally, the amplitude of the vibration generated in the vibrator 101 by the vibration excitation of the vibration exciter 102 is controlled to be within a range in which the vibrator 101 does not come into contact with the container 110 and the liquid level in the container 110 does not substantially change.

The vibration sensor 103 is attached to the vicinity of the upper end of the vibrator 101. The vibration sensor 103 measures the amplitude of the vibration generated in the vibrator 101 by the excitation. The vibration sensor 103 is an example of a measurement section configured to measure the amplitude of the vibrating vibrator 101.

The liquid level measurement device 100 is fixed to the container 110. For example, the vibrator 101 is inserted into the container 110 through a hole (not illustrated) opened in a cover 110a of the container 110, and is arranged such that a part of the vibrator is immersed in the liquid of the container 110. The vibration exciter 102 is arranged outside the cover 110a, and the vibrator 101 is fixed to the cover 110a at the upper end of the vibrator 101.

The vibration sensor 103 is arranged directly under the cover 110a, and is used to detect the motion (vibration) of the vibrator 101 in the container 110. The vibration sensor 103 is configured to be protected from corrosion by the liquid. Here, the vibration exciter 102 may be arranged in the container 110 as long as it is configured to be protected from corrosion by the liquid.

The control device 150 processes computer-executable instructions for executing various steps of a liquid level measurement method described later in the present disclosure. In the embodiment, the control device 150 may include a processing unit (not illustrated), a storage unit, and a communication interface. The control device 150 is an arithmetic device implemented by, for example, a computer, a processor, or a controller and configured to calculate the liquid level of the liquid in the container 110. The processing unit may be configured to read a program from the storage unit and execute the read program to perform various control operations. The program may be stored in the storage unit in advance, or acquired via a medium when necessary. The acquired program is stored in the storage unit, and is read from the storage unit and executed by the processing unit. The medium may be a variety of computer-readable storage media, or a communication line connected to the communication interface. The processing unit may be a central processing unit (CPU). The storage unit may include a random access memory (RAM), a read only memory (ROM), a hard disk drive (HDD), a solid state drive (SSD), or a combination thereof. The communication interface may communicate with the liquid level measurement device 100 via a communication line such as a local area network (LAN). The communication interface may communicate by wire or wirelessly with the liquid level measurement device 100.

The control device 150 transmits a control signal for starting the vibration excitation of the vibration exciter 102. The control device 150 acquires the amplitude of the vibrating vibrator 101 measured by the vibration sensor 103. The control device 150 transmits a control signal for stopping the vibration excitation of the vibration exciter 102 when the amplitude measured by the vibration sensor 103 is stabilized.

The vibration sensor 103 measures the amplitude of vibration generated in the vibrator 101 when the vibration exciter 102 stops the vibration excitation. The vibration sensor 103 may constantly measure the amplitude of vibration generated in the vibrator 101 regardless of whether the vibration excitation is stopped. The control device 150 measures the time during which, when the amplitude, measured by the vibration sensor 103 when the vibration excitation is stopped, is a first level, the amplitude of the vibrator 101 is damped to a predetermined second level with respect to the first level. For example, the control device 150 may measure the damping time during which, with respect to the amplitude of the vibrator 101 at the first level measured by the vibration sensor 103 when the vibration excitation is stopped, the amplitude is damped to the second level that is ½ to 1/10 of the first level. However, the second level is not limited thereto, and only needs to be less than the first level.

As illustrated in FIG. 1, the resistance to the motion of the vibrator 101 changes according to the area S in a direction perpendicular to the vibration direction D of the vibrator 101 immersed in the liquid. For example, as the area S of the vibrator 101 immersed in the liquid increases, the resistance value when the vibrator 101 vibrates increases, and the damping time decreases. Therefore, a correlation relationship is established such that as the liquid level becomes higher, the depth (the area S) of the vibrator 101 immersed in the liquid increases, the resistance value received from the liquid increases, and the damping time of the amplitude of the vibration generated in the vibrator 101 decreases. Therefore, if the viscosity of the liquid to be measured and the restoring force of the vibrator 101 are constant, the control device 150 can calculate the liquid level from the damping time of the amplitude of the vibrating vibrator 101 based on correlation information between the damping time and the liquid level, because the damping time changes only with the liquid level.

The correlation between the damping time and the liquid level may be indicated by a correlation equation between the damping time and the liquid level derived using an analysis model described later. The correlation equation may be stored in the storage unit. For the correlation between the damping time and the liquid level, multiple relationships between the damping time and the liquid level may be measured, and the measurement results may be stored in advance in a storage unit in the control device 150 or a storage unit connected to the control device 150. The relationship between the damping time and the liquid level may be measured for each type of liquid, and the measurement result for each type of liquid may be stored in advance in a storage unit or the like in the control device 150.

The control device 150 may calculate the liquid level from the measured damping time based on the correlation equation. Additionally, the control device 150 may calculate the liquid level from the measured damping time based on the correlation information between the damping time and the liquid level by referring to the storage unit.

When the correlation information between the damping time and the liquid level for each type of liquid is stored in advance in the storage unit based on the measured values of the damping time and the liquid level for each type of liquid, the control device 150 acquires the correlation information corresponding to the type of liquid in the container 110 from the correlation information stored in the storage unit. Then, the liquid level corresponding to the damping time may be calculated based on the acquired correlation information.

### [Liquid Level Measurement Method]

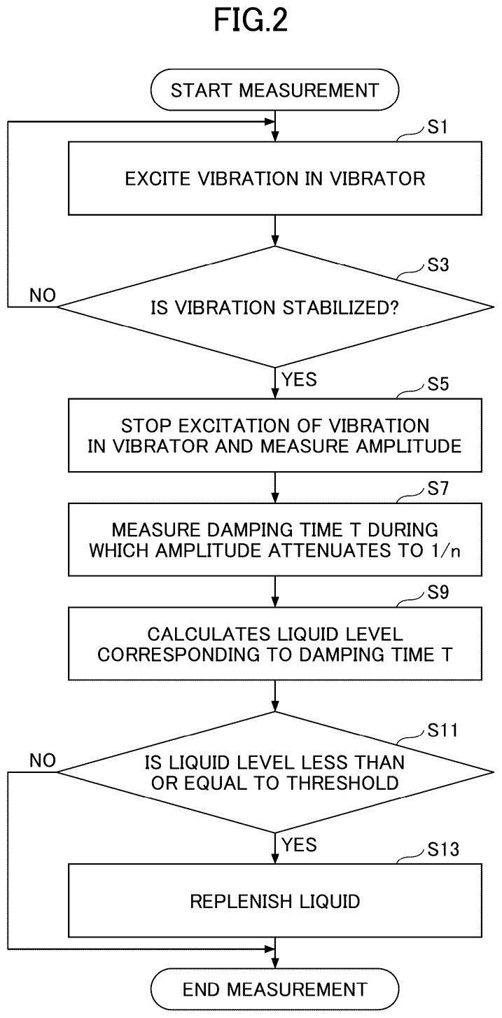

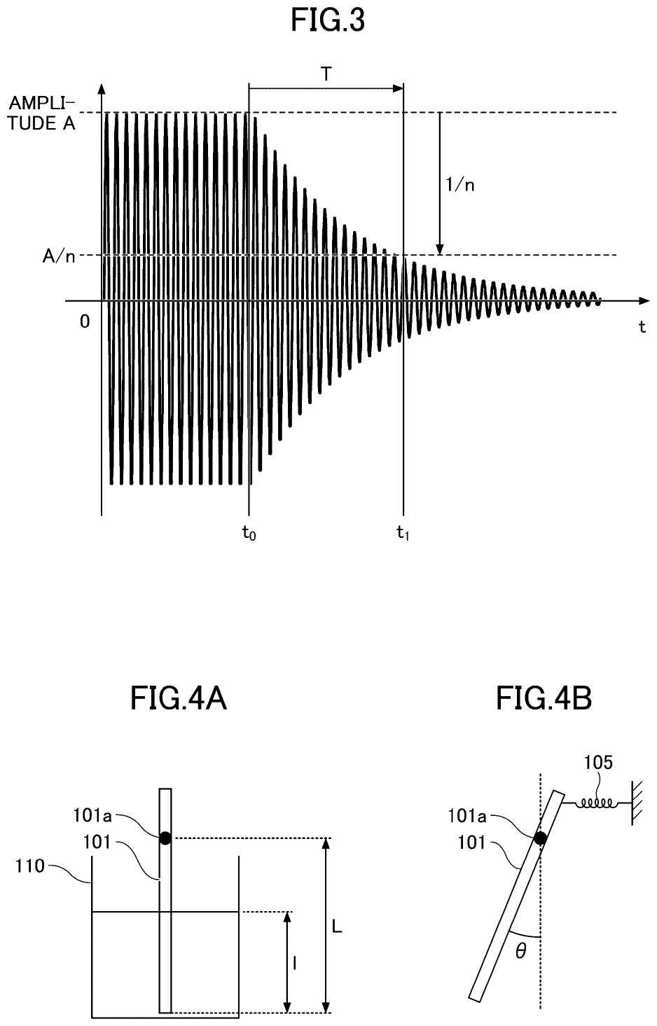

Next, the liquid level measurement method according to the embodiment will be described with reference to FIGS. 2 and 3. FIG. 2 is a flowchart illustrating an example of the liquid level measurement method according to the embodiment. FIG. 3 is a graph indicating an example of the amplitude of the vibration generated in the vibrator 101 of the liquid level measurement device 100 according to the embodiment.

When the liquid level measurement method illustrated in FIG. 2 is started, in step S1, the control device 150 excites vibration in the vibrator 101 by the vibration exciter 102. The control device 150 starts the vibration excitation by the vibration exciter 102 by controlling an actuator such as a motor for operating the vibration exciter 102, for example.

Next, in step S3, the control device 150 acquires the amplitude of vibration generated in the vibrator 101, measured by the vibration sensor 103, and determines whether the vibration of the vibrator 101 is stabilized. For example, the control device 150 may determine that the vibration of the vibrator 101 is stabilized when the fluctuation of the amplitude of the vibration generated in the vibrator 101 is within a preset allowance value. The control device 150 may determine that the vibration of the vibrator 101 is stabilized when the amplitude of the vibration generated in the vibrator 101 is a preset value.

In step S3, the control device 150 repeats steps S1 and S3 until it is determined that the vibration of the vibrator 101 is stabilized, thereby waiting until the vibration of the vibrator 101 is stabilized.

When it is determined that the vibration of the vibrator 101 is stabilized, the process proceeds to step S5 and the control device 150 stops the actuator to stop the vibration excitation of the vibrator 101 by the vibration exciter 102. The control device 150 stops the vibration excitation of the vibrator 101 by the vibration exciter 102 when, for example, the amplitude of the vibration generated in the vibrator 101 by the vibration excitation of the vibrator 101 is stabilized at the first level. The vibration sensor 103 measures the amplitude of the vibrating vibrator 101 when the vibration excitation of the vibrator 101 is stopped. The control device 150 acquires the amplitude of the vibrator 101 measured by the vibration sensor 103 when the vibration excitation of the vibrator 101 is stopped.

In an example of the amplitude of the vibration generated in the vibrator 101 illustrated in FIG. 3, the horizontal axis indicates the time, and the vertical axis indicates the amplitude of the vibration generated in the vibrator. Because the vibration of the vibrator 101 is stabilized at the amplitude A before time t₀, the vibration excitation of the vibration exciter 102 for the vibrator 101 is stopped at the time t₀. The amplitude A is an example of the amplitude of the first level.

Returning to FIG. 2, in step S7, the control device 150 measures damping time T during which the amplitude is damped to 1/n with respect to the amplitude of the vibrator 101 when the vibration excitation of the vibrator 101 is stopped. In FIG. 3, the amplitude is damped to 1/n during the damping time T from the time t₀ to time t₁.

1/n indicates the amplitude of the second level that is less than the amplitude of the first level. 1/n may be set to, for example, ¼ of the amplitude of the first level. In such a way, the control device 150 measures the time during which the amplitude of the vibration generated in the vibrator 101 when the vibration excitation of the vibrator 101 is stopped is damped from the first level to the second level.

Next, in step S9, the control device 150 calculates the liquid level corresponding to the measured damping time based on the correlation information (e.g., the correlation equation) between the damping time and the liquid level.

Next, in step S11, the control device 150 determines whether the calculated liquid level is less than or equal to a preset threshold. When the control device 150 determines that the calculated liquid level is less than or equal to the preset threshold value, liquid is replenished in the container 110 and the process is ended. When the control device 150 determines that the calculated liquid level is greater than the preset threshold value, the process is ended without replenishing the liquid.

According to the liquid level measurement method of the present embodiment, by making the amplitude of the vibrator 101 constant (for example, the amplitude A in FIG. 3), the time until the vibration is damped to a certain amplitude (for example, the amplitude A/n in FIG. 3) can be regarded as a value determined only by the drag force received by the vibrator 101 from the liquid. As the area in which the vibrator 101 is immersed in the liquid increases, the damping force increases, and the damping time decreases. Therefore, the liquid level can be calculated from the damping time corresponding to the damping force.

Additionally, according to the liquid level measurement method of the present embodiment, when compared with the float of the float switch used in the container 110, the liquid level can be measured by the length of the vibrator 101 in the longitudinal direction (the direction perpendicular to the liquid surface), linearly or in the fine step size.

Additionally, when compared with the float of the float switch, the volume occupied by the liquid level measurement device 100 is greatly reduced, so that the amount of liquid that can be accommodated in the container 110 can be increased. The material of the vibrator 101 can be freely changed. It is preferable to use the same material as that of the container 110 that is resistant to corrosive liquids for the vibrator 101, the vibration exciter 102, and the vibration sensor 103. With this, if the gas vaporized from the liquid touches the vibrator 101, the vibration exciter 102, and the vibration sensor 103, the liquid level can be measured. As illustrated in FIG. 1, when the container 110 in which the liquid level measurement device 100 is arranged is used for a device such as a vaporizer, the device can be miniaturized.

Here, in FIG. 1, the liquid level measurement device 100 is fixed to the cover 110a, and the vibrator 101 hangs down from the cover 110a and extends to the vicinity of the bottom of the container 110 so as not to touch the bottom of the container 110. When the liquid level measurement device 100 is fixed to the cover 110a in such a way, the vibration sensor 103 can be easily moved away from the liquid surface and the vibration sensor 103 can be easily protected. Additionally, the amplitude of the vibration when the vibration in the vibrator 101 is excited is the largest near the bottom of the container 110, thereby increasing the damping effect of the vibration, and enhancing the accuracy of the liquid level measurement of the liquid level measurement device 100.

However, the liquid level measurement device 100 is not limited to be fixed to the upper part of the container 110. In the liquid level measurement device 100, the vibrator 101 may extend from the bottom side of the container 110 to the vicinity of the lower surface of the cover 110a while avoiding leakage of liquid from the container 110. In this case, a tip of the vibrator 101 is located at the upper part of the container 110, the vibration sensor 103 is attached to the tip of the vibrator 101, and the vibration exciter 102 is disposed at the bottom. Therefore, the liquid level can be measured in a wider range in the height direction from the vicinity of the bottom of the container 110 to the vicinity of the lower surface of the cover 110a. Additionally, in this case, the liquid level measurement device 100 can be easily installed.

### [Analysis Model]

The damping force (the drag force) against the motion of the vibrator 101 changes in accordance with the area where the vibrator 101 is immersed in the liquid in the container 110. The area of the vibrator 101 immersed in the liquid is rectangular. Thus, as described above, the relationship is established such that as the liquid level increases, the depth (the area) in which the vibrator 101 is immersed increases, the damping force (the drag force) received from the liquid increases, and the damping time of the vibrator 101 decreases. Therefore, if the viscosity of the liquid to be measured and the restoring force of the vibrator are constant, the damping time changes only with the liquid level, and thus the liquid level can be calculated from the damping time.

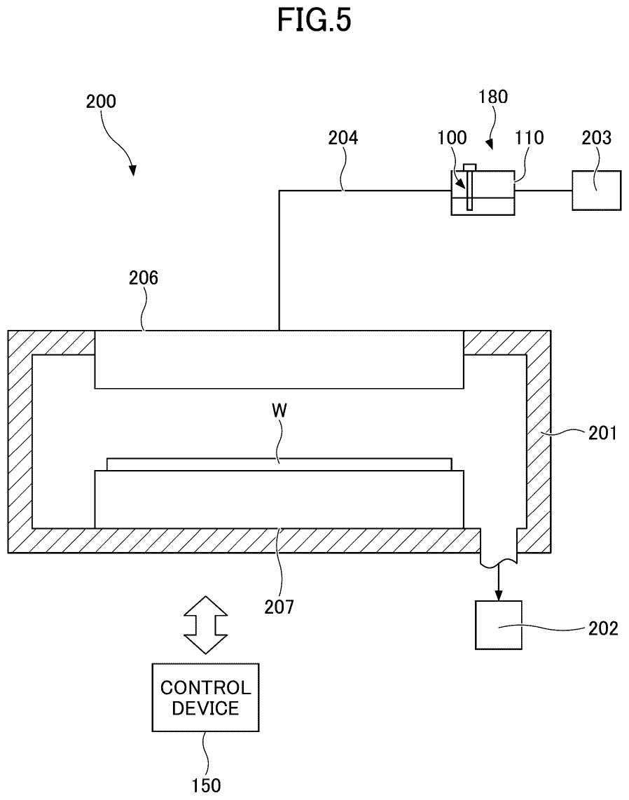

The derivation of a linear equation (a correlation equation) for calculating the liquid level from the damping time performed in an analysis model will be described below. FIG. 4A and FIG. 4B are diagrams illustrating the analysis model according to the embodiment. The analysis model used for deriving the linear equation is a model in which the vibrator 101 rotates (vibrates) as illustrated in FIG. 4B in a state of being immersed in the liquid as illustrated in FIG. 4A. L indicates the length to the tip of the vibrator 101 from a fixed point 101a where the vibrator 101 is fixed, and l indicates the length in which the vibrator 101 is immersed in the liquid. The tip of the vibrator 101 is not in contact with the bottom surface of the container 110, and thus the actual liquid level of the liquid in the container 110 is a value obtained by adding, to the liquid level l calculated in the present specification, the distance from the tip of the vibrator 101 to the bottom surface of the container 110.

In the analysis model, the vibrator 101 rotates (vibrates) using the fixed point 101a as a pivot point. The angle formed between the vibrator 101 and the axis perpendicular to the liquid surface is denoted by θ. Here, θ indicates the degree of the vibration by the vibrator 101 and is smaller than the angle illustrated in FIG. 4B. In FIG. 4B, the restoring force for an exciter in the analysis model (In FIG. 1, the vibration exciter 102) is illustrated and visualized as a spring 105.

Conditions in the analysis model illustrated in FIG. 4A and FIG. 4B are assumed as follows. The moment of inertia of the rotational motion (vibration) of the vibrator 101 is denoted as I, and the restoring force is denoted as −kθ. The restoring force is a force that the vibrator 101 is going to restore when the vibrator 101 changes by θ, and is visualized as the spring 105 in FIG. 4B, which does not actually exist.

Assuming viscous resistance (a value determined by the liquid viscosity and velocity), the moment due to the drag force is defined as follows.

$$- c \dot{θ} \qquad [ Ex . 1 ]$$

That is, the moment due to the drag force is a value obtained by multiplying the derivative of θ with the constant −c. Here, gravity and air resistance are ignored.

### (Derivation of Amplitude)

The equation of motion of the vibrator 101 in the above analysis model can be expressed by Equation (1).

$$\begin{matrix}[ Ex . 2 ] & \\ I \ddot{θ} + c \dot{θ} + k θ = 0 & ( 1 )\end{matrix}$$

The initial conditions of the equation of motion of Equation (1) are as follows.

$$θ ( 0 ) = {θ}_{0} \qquad [ Ex . 3 ]$$

$$\dot{θ} ( 0 ) = {\dot{θ}}_{0}$$

Here, with the following equation,

$${c}_{c} = 2 \sqrt{I k} , ζ = c / {c}_{c} , {ω}_{0} = \sqrt{k / I}$$

Equation (1) can be expressed as Equation (2) below. Here, c_{c} is the critical viscous damping coefficient, ζ is the damping ratio, c is the aforementioned constant (the constant of the viscous term), and ω₀ is the natural angular frequency.

$$\begin{matrix}[ Ex . 5 ] & \\ \ddot{θ} + 2 ζ {ω}_{0} \dot{θ} + {ω}_{0}^{2} θ = 0 & ( 2 )\end{matrix}$$

When ζ is greater than 0 and less than 1, Equation (2) indicates a damping vibration, which can be expressed as follows using time t. Here, c_{c}=2√Ik and ζ=c/c_{c}, and thus the damping ratio is expressed as ζ=c/2√Ik. Here, c, I, and k are constants, and their values are determined by the design method of the system illustrated in FIG. 4A and FIG. 4B. That is, the damping ratio ζ is determined by the design method of the system illustrated in FIG. 4A and FIG. 4B, and the condition 0<ζ<1 can be satisfied by adjusting the dimensions and the restoring rate at the design stage.

$$θ ( t ) = {Ce}^{- ζ {ω}_{0} t} \cdot cos ( {ω}_{0} \sqrt{1 - {ζ}^{2}} t - α ) \qquad [ Ex . 6 ]$$

$$C = {θ}_{0} \sqrt{1 + {( \frac{ζ}{\sqrt{1 - {ζ}^{2}}} )}^{2}}$$

$$α = - {tan}^{- 1} ( - \frac{ζ}{\sqrt{1 - {ζ}^{2}}} )$$

In the analysis model, with respect to the motion state of the vibrator 101, it is only necessary to pay attention to the amplitude of the vibrator 101. Therefore, when the term of the amplitude a(t) is extracted, a(t) can be expressed by Equation (3).

$$\begin{matrix}[ Ex . 7 ] & \\ a ( t ) = C {e}^{- ζ {ω}_{0} t} = {Ce}^{- \frac{c}{2 I} t} & ( 3 )\end{matrix}$$

Equation (3) indicates that the amplitude a(t) decreases exponentially as t increases.

### (Derivation of Damping Time)

Time T required for the amplitude a(t) to be damped from A to A/n (see FIG. 3) will be calculated. That is, when the amplitude a(0) at the time t₀ is A and the amplitude a(T) at the time t₁ is A/n, a(0) is equal to na(T). In this case, the following equation is established from Equation (3).

$${Ce}^{- \frac{c}{2 I} 0} = n {Ce}^{- \frac{c}{2 I} T} \qquad [ Ex . 8 ]$$

$$1 = n {e}^{- \frac{c}{2 I} T}$$

$$0 = log n - \frac{c}{2 I} T$$

By rearranging this equation, Equation (4) for the damping time T is derived.

$$\begin{matrix}[ Ex . 9 ] & \\ T = \frac{2 I}{c} log n & ( 4 )\end{matrix}$$

### (Moment Due to Drag Force)

The drag force received by the vibrator 101 in the liquid is obtained. Considering only the viscous resistance, the drag force received per unit length of the vibrator 101 can be expressed as −k_{c}v using the velocity v and the constant k_{c}.

At this time, the moment about the pivot due to the drag force received by a portion of the vibrator 101 at a distance x from the fixed point 101a can be expressed by the following equation.

$$x ( - {k}_{c} v ) = - {k}_{c} {x}^{2} \dot{θ} \qquad [ Ex . 10 ]$$

With this, the moment received by the portion of the vibrator 101 immersed in the liquid is calculated by integrating the previous equation from L−1 to L, when the portion 1 of L is immersed.

$${\int }_{L - l}^{L} ( - {k}_{c} {x}^{2} \dot{θ} ) dx = - \frac{1}{3} {k}_{c} ( {l}^{3} - 3 L {l}^{2} + 3 {L}^{2} l ) \dot{θ} ( = - c \dot{θ} ) \qquad [ Ex . 11 ]$$

From this equation, Equation (5) is derived.

$$\begin{matrix}[ Ex . 12 ] & \\ c = \frac{1}{3} {k}_{c} ( {l}^{3} - 3 L {l}^{2} + 3 {L}^{2} l ) & ( 5 )\end{matrix}$$

### (Derivation of Liquid Level 1)

From Equation (4) and Equation (5), the relationship between the length 1 of the vibrator 101 immersed in the liquid and the damping time T is indicated by Equation (a) below.

$$\begin{matrix}[ Ex . 13 ] & \\ l ( {l}^{2} - 3 L l + 3 {L}^{2} ) = \frac{6 I}{{k}_{c} T} log n & ( a )\end{matrix}$$

In Equation (a), k_{c} is a constant value determined by the cross-sectional shape of the vibrator 101 and the viscosity of the liquid. Additionally, n, I, and L are all constants. Therefore, because the left side of Equation (a) is a monotonic increasing function, l is uniquely determined if the damping time T is found.

In the above analysis model, viscous resistance is assumed and the drag force received per unit length of the vibrator 101 is calculated. However, the drag force acting on an object moving in liquid is generally velocity square resistance. In the case of velocity square resistance, the equation of motion is expressed by the following equation.

$$I \ddot{θ} + {c}^{′} {\dot{θ}}^{2} + k θ = 0 \qquad [ Ex . 14 ]$$

As described above, although the actual model would be a more complicated nonlinear equation, the relationship that the damping force increases as the liquid level increases is not broken. Therefore, a correlation equation such as equation (a) can be used.

### [Substrate Processing Device]

The liquid level measurement device 100 described above can be installed and used in various devices. Next, an example of using the liquid level measurement device 100 attached to a vaporizer 180 will be described with reference to FIG. 5. FIG. 5 is a diagram illustrating an example of the vaporizer 180 and a film deposition apparatus 200 according to the embodiment. The film deposition apparatus 200 illustrated in FIG. 5 is an example of a substrate processing apparatus.

The film deposition apparatus 200 includes a chamber 201, an exhaust device 202, a shower head 206, and a stage 207. In the present embodiment, the film deposition apparatus 200 is, for example, a chemical vapor deposition (CVD) apparatus.

The shower head 206 is provided at an upper portion of the chamber 201. Gas is supplied to the chamber 201 via the shower head 206. A raw material supply source 203 containing a liquid film deposition material is connected to the shower head 206 via a pipe 204.

The film deposition material supplied from the raw material supply source 203 is stored in a container 110 of the vaporizer 180 interposed in the pipe 204. In the vaporizer 180, the liquid film deposition material is heated by a heater (not illustrated) installed in the container 110 and vaporized. The raw material gas vaporized by the vaporizer 180 is introduced into the shower head 206 through the pipe 204.

Many discharge holes (not illustrated) are formed in the lower surface of the shower head 206. The shower head 206 discharges the raw material gas introduced through the pipe 204 into the chamber 201 in a shower-like manner. The exhaust device 202 exhausts the gas in the chamber 201. The inside of the chamber 201 is controlled to a vacuum atmosphere of a predetermined pressure by the exhaust device 202. The exhaust device 202 is controlled by the control device 150.

The stage 207 on which the substrate W is mounted is provided in the chamber 201. The substrate W is supported by the stage 207. In the stage 207, a heater (not illustrated) for adjusting the temperature of the substrate W is provided. By controlling the heater, the control device 150 controls the temperature of the substrate W so that the upper surface of the substrate W becomes a temperature suitable for film deposition of the raw material gas.

By using such a film deposition apparatus 200, film deposition with the raw material gas can be performed on the surface of the substrate W. Here, the film deposition apparatus 200 can deposit a desired film on the substrate W by supplying reaction gas together with the raw material gas.

The liquid level measurement device 100 is attached to the container 110 of the vaporizer 180. The liquid level measurement device 100 measures the liquid level of the raw material in the container 110. For example, when the liquid level falls below the threshold, the liquid film deposition material can be automatically replenished in the container 110.

However, the use of the liquid level measurement device 100 is not limited to this. For example, the liquid level measurement device 100 can be used in a liquid supply device. For raw materials with low vapor pressure that cannot be vaporized by a method of heating the container itself, a pipe such as a straw is inserted into the container of the liquid supply device and N₂ gas or Ar gas is supplied to a space in the container. With this, the liquid in the container is pushed out by applying pressure to the upper space in the container. The liquid that is pushed out is supplied to a pipe including a heating section such as a heater, and can be vaporized by heating. The liquid level measurement device 100 measures the liquid level of the liquid supply device. When the liquid level falls below the threshold, the liquid can be automatically replenished in the container 110.

As described above, according to the liquid level measurement method and liquid level measurement device 100 of the present embodiment, the liquid level in a container can be measured linearly (continuously) with high accuracy.

The liquid level measurement method and liquid level measurement device of the present embodiment should be considered to be exemplary in all respects and not restrictive. The embodiments can be modified and improved in various forms without departing from the scope and spirit of the appended claims. The matters described in the above multiple embodiments can have other configurations as long as there is no contradiction, and can be combined as long as there is no contradiction.

Here, the substrate processing apparatus disclosed herein can be applied to a single wafer processing apparatus, a batch processing apparatus and a semi-batch processing apparatus for processing multiple substrates at once. The substrate processing apparatus disclosed herein performs substrate processing such as film deposition processing and etching processing, for example. The substrate processing apparatus disclosed herein may be an apparatus that performs substrate processing using plasma or an apparatus that performs substrate processing without using plasma.

What is claimed is:

1. A liquid level measurement method performed by using a liquid level measurement device including a vibrator immersed in a liquid in a container, a surface of the vibrator perpendicular to a vibration direction having a rectangular shape, the liquid level measurement method comprising:
exciting, by a vibration exciter, vibration in the vibrator;
measuring damping time during which an amplitude of the vibration generated in the vibrator is damped to a predetermined level when the excitation of the vibration in the vibrator is stopped; and
calculating, based on correlation information between the damping time and a liquid level of the liquid, the liquid level corresponding to the damping time during which the amplitude of the vibration generated in the vibrator is damped to the predetermined level.

2. The liquid level measurement method as claimed in claim 1, wherein the calculating of the liquid level includes calculating the liquid level corresponding to the damping time based on the correlation information represented by the following equation (a) when the damping time is T and the liquid level of the liquid is 1:
$$l ( {l}^{2} - 3 L l + 3 {L}^{2} ) = \frac{6 I}{{k}_{c} T} log n \qquad ( a )$$
where I is moment of inertia of the vibrator, L is a distance from a pivot point of the vibrator to a tip of the vibrator, and k_{c}, n, I, and L are constants.

3. The liquid level measurement method as claimed in claim 1, further comprising storing, in a storage unit in advance, the correlation information between the damping time and the liquid level of the liquid, based on measured values of the damping time and the liquid level of the liquid, and
wherein the calculating of the liquid level includes calculating the liquid level corresponding to the damping time during which the amplitude of the vibration generated in the vibrator is damped to the predetermined level, based on the correlation information by referring to the storage unit.

4. The liquid level measurement method as claimed in claim 3,
wherein the storing of the correlation information includes storing, in the storage unit in advance, the correlation information for each type of the liquid, based on measured values of damping time and a liquid level for each type of the liquid, and
wherein the calculating of the liquid level includes calculating the liquid level corresponding to the damping time during which the amplitude of the vibration generated in the vibrator is damped to the predetermined level, based on the correlation information corresponding to a type of the liquid in the container among the correlation information stored in the storage unit.

5. The liquid level measurement method as claimed in claim 1, further comprising stopping the excitation of the vibration in the vibrator by the vibration exciter in response to detecting that the amplitude of the vibration generated in the vibrator is stabilized at a first level by the excitation of the vibration in the vibrator,
wherein the measuring of the damping time including measuring time during which the amplitude of the vibration is damped from the first level to a second level that is less than the first level.

6. The liquid level measurement method as claimed in claim 5, wherein the second level is ½ to 1/10 of the first level.

7. The liquid level measurement method as claimed in claim 1, further comprising replenishing the liquid in the container in response to determining that the calculated liquid level is less than or equal to a preset threshold.

8. A liquid level measurement device comprising:
a vibrator immersed in a liquid in a container, a surface of the vibrator perpendicular to a vibration direction having a rectangular shape;
a vibration exciter configured to excite vibration in the vibrator;
a measurement section configured to measure an amplitude of the vibrator vibrating by the excitation of the vibration; and
a controller configured to calculate a liquid level of the liquid;
wherein the controller is configured to:
excite the vibration in the vibrator;
measure damping time during which the amplitude of the vibration generated in the vibrator is damped to a predetermined level when the excitation of the vibration in the vibrator is stopped; and
calculate, based on correlation information between the damping time and a liquid level of the liquid, the liquid level corresponding to the damping time during which the amplitude of the vibration generated in the vibrator is damped to the predetermined level.

9. The liquid level measurement device as claimed in claim 8, wherein the controller calculates the liquid level corresponding to the damping time during which the amplitude of the vibration generated in the vibrator is damped to the predetermined level, based on the correlation information indicated by the following equation (a), when the damping time is T and the liquid level of the liquid is l:
$$l ( {l}^{2} - 3 L l + 3 {L}^{2} ) = \frac{6 I}{{k}_{c} T} log n \qquad ( a )$$
where I is moment of inertia of the vibrator, L is a distance from a pivot point of the vibrator to a tip of the vibrator, and k_{c}, n, I, and L are constants.

10. The liquid level measurement device as claimed in claim 8,
wherein the controller stores, in a storage unit in advance, the correlation information between the damping time and the liquid level of the liquid based on measured values of the damping time and the liquid level of the liquid, and
wherein the calculating of the liquid level includes calculating the liquid level corresponding to the damping time during which the amplitude of the vibration generated in the vibrator is damped to the predetermined level, based on the correlation information by referring to the storage unit.

11. The liquid level measurement device as claimed in claim 8, wherein the liquid level measurement device is provided in a vaporizer including the container.

12. The liquid level measurement device as claimed in claim 11, wherein the vaporizer is connected to a substrate processing apparatus via a pipe, and the liquid in the vaporizer is vaporized and supplied to the substrate processing apparatus.

13. The liquid level measurement device as claimed in claim 8, wherein the vibrator is formed of a same material as the container.
